(19) United States
(12) Patent Application Publication
(10) Pub. No.: US 2006/0112267 A1
(43) Pub. Date: May 25, 2006

(54) Trusted platform storage controller

(76) Inventors: Vincent J. Zimmer, Federal Way, WA (US); Michael A. Rothman, Puyallup, WA (US)

Correspondence Address: Grossman, Tucker, Perreault & Pfleger, PLLC;PortfolioIP, P.O. Box 52050, Minneapolis, MN, 55402, US

(21) Appl. No.: 10/996,105

(22) Filed: Nov. 23, 2004

(51) Int. Cl. H04L 9/00

(52) U.S. Cl. 713/164

(57) ABSTRACT

A method according to one embodiment includes accessing via a private link at least one security function provided by a trusted platform module (TPM), and controlling storage of data in mass storage utilizing the at least one security function. Of course, many alternatives, variations, and modifications are possible without departing from this embodiment.

### FIELD

This disclosure relates to a trusted platform storage controller.

### BACKGROUND

A conventional data storage system may include one computing device capable of bidirectional communication with mass storage. The computing device may include a computer node having a storage controller. The storage controller may control the storage of data in, and the retrieval of data from, mass storage. Mass storage may include a redundant array of independent disks (RAID). The storage controller may provide a way of accessing the plurality of hard disks of the RAID as if the array were one larger disk. The storage controller may utilize one or more RAID levels to store and retrieve data from the disks to improve input/output (I/O) performance, reliability of data storage in case of failure of one of the disks (e.g., by redundant storage of data) or a combination of both.

To enhance security of computing, some computing devices may utilize a “trusted platform module” (TPM). The TPM may be a hardware component coupled to a bus of the computing device, e.g., a low pin count (LPC) bus. However, a conventional storage controller can not access the functionality provided by the TPM because the TPM is on a separate I/O bus, e.g., the LPC bus. In addition, the conventional storage controller is an I/O device that can not generate peer-to-peer traffic to such a LPC bus attached TPM.

One drawback of this conventional separate TPM and storage controller arrangement is the inability of the storage controller to use the security functions provided by the TPM. For example, an unauthorized person may remove a hard disk from the RAID of one platform and may gain access to sensitive data on that disk by using it in another platform. Another drawback of the conventional separate TPM and storage controller arrangement is increased cost as two separate components, packaging, and connectivity to the host platform are necessary.

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a diagram illustrating a system embodiment;

FIG. 2 is a diagram illustrating an integrated circuit in the system embodiment of FIG. 1;

FIG. 3 is a diagram illustrating in greater detail the integrated circuit of FIG. 2;

FIG. 4 is a flow chart illustrating operations according to an embodiment; and

FIG. 5 is a flow chart illustrating operations according to another embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

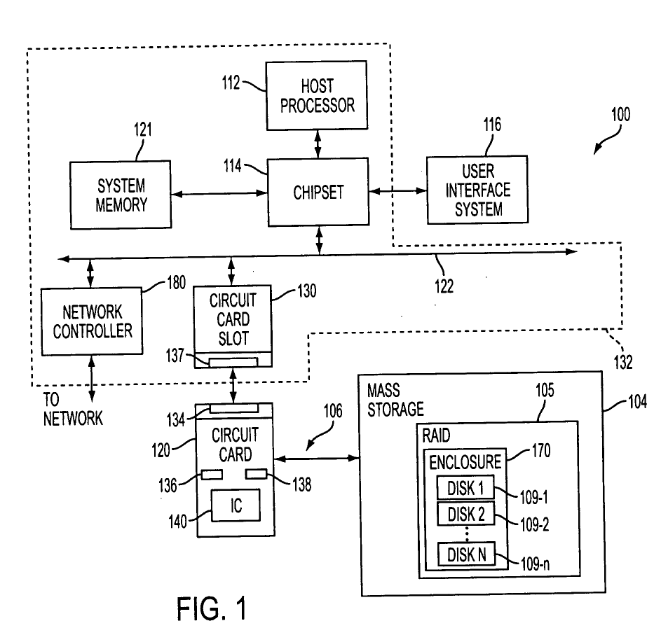

FIG. 1 illustrates a system embodiment 100 of the claimed subject matter. The system 100 may include a computer node having a host bus adapter (HBA), e.g., circuit card 120. The circuit card 120 may be capable of bidirectional communication with mass storage 104 via one or more communication links 106 using one or more communication protocols.

The system 100 may generally include a host processor 112, a bus 122, a user interface system 116, a chipset 114, system memory 121, a network controller 180, and a circuit card slot 130. The host processor 112 may include one or more processors known in the art such as an Intel® Pentium® IV processor commercially available from the Assignee of the subject application. The bus 122 may include various bus types to transfer data and commands. For instance, the bus 122 may comply with the Peripheral Component Interconnect (PCI) Express™ Base Specification Revision 1.0, published Jul. 22, 2002, available from the PCI Special Interest Group, Portland, Oreg., U.S.A. The bus 122 may alternatively comply with the PCI-X Specification Rev. 1.0a, Jul. 24, 2000, available from the aforesaid PCI Special Interest Group, Portland, Oreg., U.S.A.

The user interface system 116 may include one or more devices for a human user to input commands and/or data and/or to monitor the system 100 such as, for example, a keyboard, pointing device, and/or video display. The chipset 114 may include a host bridge/hub system (not shown) that couples the processor 112, system memory 121, and user interface system 116 to each other and to the bus 122. The chipset 114 may include one or more integrated circuit chips, such as those selected from integrated circuit chipsets commercially available from the Assignee of the subject application (e.g., graphics memory and I/O controller hub chipsets), although other integrated circuit chips may also, or alternatively be used. A network controller 180 may also be coupled to the bus 122 and provide a connection to an associated network and hence other devices coupled to the network. The network controller 180 may be implemented as a “card” in some embodiments but may also be implemented on a circuit board such a motherboard 132. The network controller 180 may also exchange data and/or commands with system memory 121, host processor 112, and/or user interface system 116 via the bus 122 and chipset 114. The processor 112, system memory 121, chipset 114, bus 122, network controller 180, and the circuit card slot 130 may be on one circuit board such as the system motherboard 132.

The circuit card 120 may control storage of data in, and retrieval of data from, mass storage 104. Mass storage 104 may include a redundant array of independent disks (RAID) 105. A plurality of hard disks 109-1, 109-2 . . . 109-n may be comprised in the RAID 105. Each disk 109-1, 109-2 . . . 109-n may be accessed independently by circuit card 120, and may further be capable of being identified by circuit card 120 using, for example, disk identification information. Each disk may store data thereon in selected units, for example, large block address (LBA), sectors, clusters, and/or any combination thereof. The disks 109-1, 109-2 . . . 109-n may also be comprised in one or more enclosures such as enclosure 170. Enclosure 170 may be separate from another enclosure that includes the motherboard 132.

The circuit card 120 may be constructed to permit it to be inserted into the circuit card slot 130. When the circuit card 120 is properly inserted into the slot 130, connectors 134 and 137 become electrically and mechanically coupled to each other. When connectors 134 and 137 are so coupled to each other, the card 120 becomes electrically coupled to bus 122 and may exchange data and/or commands with system memory 121, host processor 112, and/or user interface system 116 via bus 122 and chipset 114.

Alternatively, without departing from this embodiment, the operative circuitry of the circuit card 120 may be included in other structures, systems, and/or devices. These other structures, systems, and/or devices may be, for example, in the motherboard 132, and coupled to the bus 122. These other structures, systems, and/or devices may also be, for example, comprised in chipset 114.

The circuit card 120 may communicate with mass storage 104 via communication link 106 using one or more communication protocols. Exemplary communication protocols may include, but are not limited to, Fibre Channel (FC), Serial Advanced Technology Attachment (SATA), Serial Attached Small Computer Systems Interface (SAS) protocol, Internet Small Computer System Interface (iSCSI), and/or asynchronous transfer mode (ATM).

If a FC protocol is used, it may comply or be compatible with the interface/protocol described in ANSI Standard Fibre Channel Framing and Signaling Specification, 2 Rev 0.3 T11/1619-D, dated Sep. 7, 2004. Alternatively, if a S-ATA protocol is used, it may comply or be compatible with the protocol described in “Serial ATA: High Speed Serialized AT Attachment,” Revision 1.0a, published on Jan. 7, 2003 by the Serial ATA Working Group, and the Extension to SATA, 1.0a Rev 1.2, dated Aug. 27, 2004. Further alternatively, if a SAS protocol is used, it may comply or be compatible with the protocol described in “Information Technology—Serial Attached SCSI—1.1 (SAS),” Working Draft American National Standard of International Committee For Information Technology Standards (INCITS) T10 Technical Committee, Project T10/1562-D, Revision 6, published Oct. 2, 2004, by American National Standards Institute (hereinafter termed the “SAS Standard”) and/or later-published versions of the SAS Standard. Further alternatively, if an iSCSI protocol is used, it may comply or be compatible with the protocol described in “IP Storage Working Group, Internet Draft, draft-itef-ips-iscsi-21.txt”, published Apr. 29, 2004 by the Internet Engineering Task Force (IETF) and/or later published versions of the same. Further alternatively, if an ATM protocol is used, it may comply or be compatible with the plurality of ATM Standards approved by the ATM Forum including, for example, “ATM User-Network Interface (UNI) Signaling Specification” published April 2002 by the ATM Forum.

The circuit card 120 may comprise an integrated circuit (IC) 140. The IC 140 may comprise a trusted platform storage controller. As used herein, an “integrated circuit” or IC means a semiconductor device and/or microelectronic device, such as, for example, a semiconductor integrated circuit chip. The circuit card 120 may also comprise computer-readable boot code memory 136 and computer-readable memory 138. Memories 136 and/or 138 each may comprise one or more of the following types of memories: semiconductor firmware memory, programmable memory, non-volatile memory, read only memory, electrically programmable memory, random access memory, flash memory, magnetic disk memory, and/or optical disk memory. Either additionally or alternatively, memories 136 and/or 138 each may comprise other and/or later-developed types of computer-readable memory.

Machine-readable firmware program instructions may be stored in memory 138. These instructions may be accessed and executed by the IC 140 or components therein. When executed, these instructions may result in the IC 140 or components therein performing the operations described herein as being performed by the IC 140 or components therein.

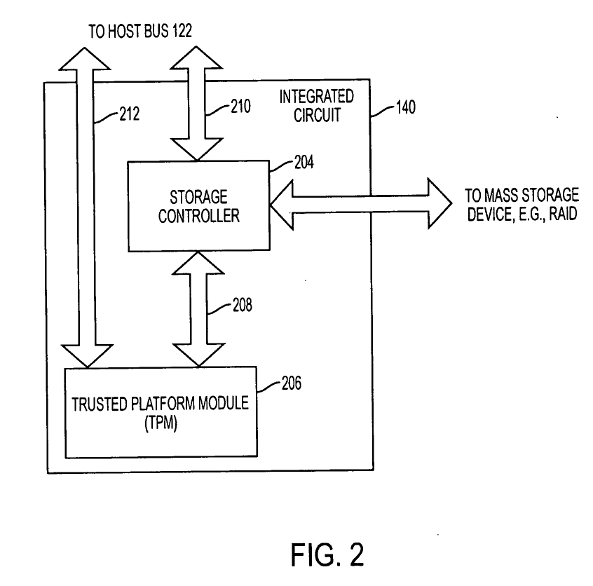

FIG. 2 illustrates the IC 140 of FIG. 1 in more detail. The IC 140 may generally include a storage controller 204 and a TPM 206 that may privately communicate with each other via a private link 208. This may enable the storage controller 204 to access within the same computational domain one or more security functions provided by the TPM 206. A host processor, e.g., host processor 112 of FIG. 1, may also access the TPM 206 via link 212 and the host bus 122. As used herein, a “link” may be broadly defined as one or more information carrying mediums such as electrical wire, optical fiber, cable, trace, or even a wireless channel using infrared, radio frequency, or any other wireless signaling mechanism. The “private” nature of the link 208 means the link may provide communication between the storage controller 204 and the TPM 206, without communication to other external components. As earlier indicated, the IC 140 including the storage controller 204 and TPM 206 may alternatively be coupled directly to the motherboard 132 as opposed to the circuit card 120. For example, in that instance the storage controller 204 may be a RAID on motherboard (ROMB) type controller.

The storage controller 204 may generally control storage of data in and retrieval of data from, mass storage 104 (e.g., the plurality of disks 109-1, 109-2 . . . 109-n of the RAID 105 in one embodiment). The TPM 206 may provide at least one security function. The storage controller 204 may access, via the private link 208, at least one of the security functions provided by the TPM 206. The storage controller 204 may also control storage of data in mass storage utilizing at least one of the security functions provided by the TPM 206.

The TPM 206 may be implemented as hardware, firmware, and/or software and may provide a plurality of security functions. The TPM 206 may comply or be compatible with one or more of the TPM Specifications published by the Trusted Computing Group (TCG). These TPM Specifications may include, but not be limited to: the “TCG Specification Architecture Overview” Specification, Revision 1.2, published Apr. 28, 2004 by the TCG; the “TPM Main Part 1 Design Principles” Specification, Version 1.2, published Oct. 2, 2003 by the TCG; the “TPM Main Part 2 TPM Structures” Specification, Version 1.2, published Oct. 2, 2003 by the TCG; and the “TPM Main Part 3 Commands” Specification, Version 1.2, published Oct. 2, 2003 by the TCG.

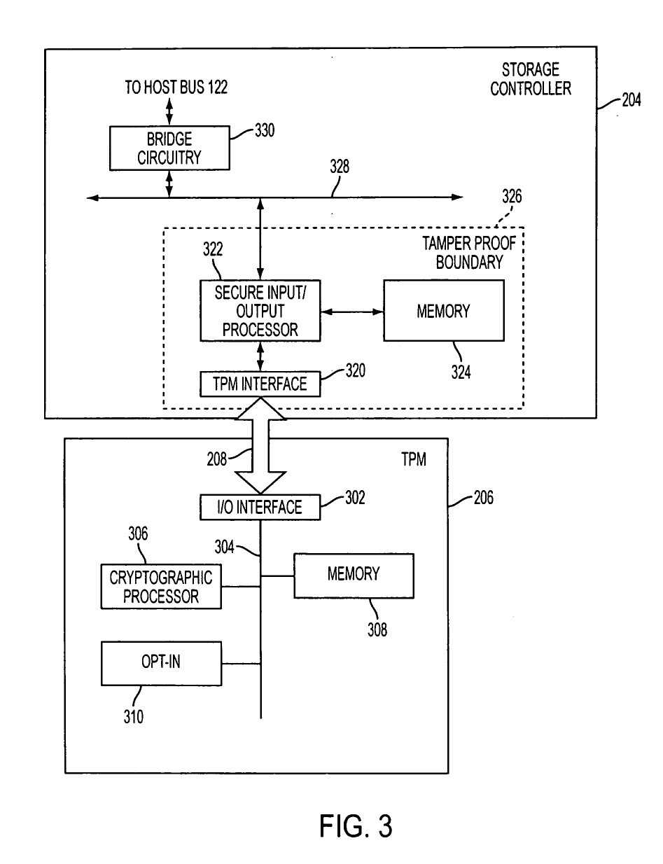

FIG. 3 illustrates the IC 140 which may comprise the storage controller 204 and TPM 206. The TPM 206 may include an Input/Output (I/O) interface 302, internal communications bus 304, cryptographic processor 306, memory 308, and opt-in circuitry 310. As used herein, “circuitry” may comprise, for example, singly or in any combination, hardwired circuitry, programmable circuitry, state machine circuitry, and/or firmware that stores instructions executed by programmable circuitry. Additional functional elements (not illustrated) may also be included in the TPM 206, and such functional elements may be consistent with those components detailed in the previously referenced TPM Specifications. The I/O interface 302 may manage communication flow from external components such as from the storage controller 204. The I/O interface 302 may also manage communication flow from other components such as the host processor 112 via link 212 (see FIG. 2). The I/O interface 302 may also manage communication flow over the internal communications bus 304. The I/O interface 302 may also enforce access policies associated with other components such as the opt-in circuitry 310.

The cryptographic processor 306 may implement cryptographic operations. Cryptographic operations may be security functions to provide data security. Security functions may include, but not be limited to, data encryption and decryption, key generation, hashing, and random number generation. Encryption operations may convert data into an encrypted form that cannot be easily understood by unauthorized personnel. In order to recover the encrypted data, a correct decryption key may be needed to “undo” the work of an encryption algorithm associated with the encryption function. Memory 308 may include non-volatile and volatile memory. Non-volatile memory may be used to store keys such as endorsement keys and storage root keys. The opt-in circuitry 310 may provide mechanisms and protections to allow the TPM 206 to be shipped in a state a customer desires such as turned on/off, enabled/disabled, or activated/deactivated. The opt-in circuitry 310 may maintain logic and, if necessary, interfaces to ensure other TPM components are disabled as necessary.

The storage controller 204 may include a TPM interface 320, a secure input/output processor 322, and memory 324. The TPM interface 320 may manage communication flow between the storage controller 204 and the TPM 206. Such communication flow may enable the storage controller 204 to have access to one or more security functions provided by the TPM 204. The processor 322 may include processor core circuitry that may comprise a plurality of processor cores. As used herein, a “processor core” may comprise hardwired circuitry, programmable circuitry, and/or state machine circuitry. Machine readable program instructions may be stored in any variety of machine readable media, e.g., the processor core may have a set of micro-code program instructions that may be executed by the processor 322, such that when such instructions are executed by the processor 322 it may result in the processor 322 performing operations described herein. The memory 324 may include one or more machine readable storage media such as random-access memory (RAM), dynamic RAM (DRAM) including synchronous DRAM, flash memory, static RAM (SRAM) magnetic disk (e.g. floppy disk and hard drive) memory, optical disk (e.g. CD-ROM) memory, and/or any other device that can store information.

Each of the TPM interface 320, the processor 322, and memory 324 may be comprised in a tamper proof boundary 326. The tamper proof boundary 326 may include tamper-resistant packaging which may be difficult to remove or replace and may further physically hide what is taking place on the components inside the packaging. The tamper proof packaging may also limit pin probing. In one embodiment, the tamper proof boundary 326 and the TPM 206 may be glued to the circuit card 120 to deter physical removal of such components and if any such removal takes place it may be evident upon visual inspection.

The storage controller 204 may also include bus 328 and bridge circuitry 330. The bus 328 may permit the exchange of data and/or commands between the processor 322 and other components. The bridge circuitry 330 may bridge the bus 328 to eventually the host bus 122, e.g., via host interface circuitry (not illustrated) when the circuit card 120 is coupled to the circuit card slot 130.

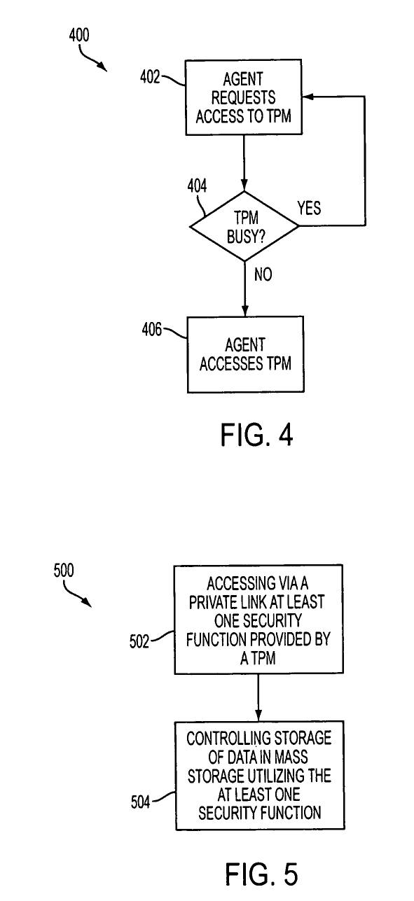

FIG. 4 illustrates operations 400 according to one embodiment. Both the storage controller 204 (via the private link 208) and the host processor 112 (via link 212) may access to one or more of the security functions provided by the TPM 206. Accordingly, the TPM 206 may mediate access to its security functions. Operation 402 may include an agent requesting access to the TPM. An “agent” may be any device requesting access to the TPM 206, for example, the storage controller 204 or the processor 112. Operation 404 inquires if the TPM is busy, e.g., currently providing access to another agent. If busy, the agent requesting access to the TPM may wait for a predetermined time interval or continue to make a request to the TPM until the TPM is not busy. If the TPM is not busy, operation 406 may permit the requesting agent to have access to one or more of the security functions of the TPM.

For example, the host processor 112 may be accessing the TPM 204 and accordingly the TPM may be busy in operation 404. The storage controller 204 may also desire access to the TPM at that time. The storage controller 204 may wait until the host processor 112 is no longer accessing the TPM before it is permitted access to the TPM. In one embodiment, such mediating access operations may be performed by the I/O interface 302 of the TPM 204. Once communication is established with the storage controller 204 or the host processor, communication between the TPM 206 and such agents may take place via a particular communication protocol. In one embodiment, such communication protocol may comply or be compatible with the object-independent authorization protocol (OIAP) as described in the previously cited TPM Specifications.

FIG. 5 is a flow chart of operations 500 consistent with another embodiment. Operation 502 may include accessing via a private link at least one security function provided by a TPM. Operation 504 may include controlling storage of data in mass storage utilizing the at least one security function.

Mass storage 104 may comprise a RAID 105 in an associated enclosure 170. At least one of the disks 109-1, 109-2 . . . 109-n of the RAID 105, e.g., disk 109-1, may be removable from the enclosure 170. The at least one security function may be data encryption such that at least a portion of the information stored in the removable disk 109-1 may be encrypted. This effectively enables the removable disk 109-1 to be tied to its original platform.

If an unauthorized person removes the disk 109-1 from the enclosure 170 and inserts the disk into another platform, the encrypted information on the disk 109-1 may deter an unauthorized person from reading data on the disk 109-1. For those RAID levels, e.g., RAID level 5, utilizing parity data, the parity data may be encrypted. Metadata about the RAID may also be encrypted. Such metadata may include, but not be limited to, the stripe size, logical volume mapping, and the RAID level.

In another embodiment, the semiconductor non-volatile memory of a conventional TPM may be displaced by utilizing the IC 140 including the storage controller 204 and TPM 206 combination. In this embodiment, the storage controller 204 may be capable of reserving a portion of the mass storage 104 for the internal storage needs of the TPM, e.g., for the non-volatile memory needs of the TPM. Therefore, the conventional semiconductor non-volatile memory of the TPM may be eliminated and a “virtual” non-volatile memory may be created by the storage controller 204. For example, this virtual non-volatile memory may be part of a disk of the RAID 105.

It will be appreciated that the functionality described for all the embodiments described herein, may be implemented using hardware, firmware, software, or a combination thereof.

Thus, in summary, one embodiment may comprise an apparatus. The apparatus may comprise an integrated circuit. The integrated circuit may comprise a storage controller and a TPM. The storage controller may be capable of accessing via a private link at least one security function provided by the TPM. The storage controller may further be capable of controlling storage of data in mass storage utilizing the at least one security function.

Another embodiment may comprise an article. The article may comprise a machine readable medium having stored thereon instructions that when executed by a machine results in the following: accessing via a private link at least one security function provided by a TPM; and controlling storage of data in mass storage utilizing the at least one security function.

Yet another embodiment may include a system. The system may comprise a circuit card. The circuit card may comprise an integrated circuit. The circuit card may be capable of being coupled to a bus. The integrated circuit may comprise a storage controller and a TPM. The storage controller may be capable of accessing via a private link at least one security function provided by the TPM. The storage controller may further be capable of controlling storage of data in mass storage utilizing the at least one security function.

Advantageously, in these embodiments the TPM and the storage controller have a private link with each other. The storage controller may then access within the same computational domain one or more of the security functions provided by the TPM. Such security functions may be utilized to effectively bind a removable disk of a RAID to a particular platform to deter unauthorized removal and attempted reading of data on such disk. In addition, the TPM and storage controller may be combined onto one integrated circuit thereby effectively reducing costs and simplifying connectivity to a host platform.

The terms and expressions, which have been employed herein, are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A method comprising:
accessing via a private link at least one security function provided by a trusted platform module (TPM); and
controlling storage of data in mass storage utilizing said at least one security function.

2. The method of claim 1, wherein said at least one security function comprises data encryption.

3. The method of claim 2, wherein said mass storage comprises a redundant array of independent disks in an associated enclosure, and wherein at least one disk of said redundant array of independent disks is removable from said enclosure, and wherein at least a portion of information stored in said at least one disk is encrypted.

4. The method of claim 3, wherein said portion of said information stored in said at least one disk comprises parity data.

5. The method of claim 1, wherein a storage controller accesses said TPM via said private link and wherein a host processor also accesses said TPM via another link, said method further comprising mediating access to said TPM between said storage controller and said host processor.

6. The method of claim 5, wherein if said host processor is accessing said TPM, said mediating access operation comprises waiting until said host processor is no longer accessing said TPM before allowing said storage controller to access said TPM.

7. An apparatus comprising:
an integrated circuit comprising a storage controller and a trusted platform module (TPM), said storage controller capable of accessing via a private link at least one security function provided by said TPM, said storage controller further being capable of controlling storage of data in mass storage utilizing said at least one security function.

8. The apparatus of claim 7, wherein said at least one security function comprises data encryption.

9. The apparatus of claim 8, wherein said mass storage comprises a redundant array of independent disks in an associated enclosure, and wherein at least one disk of said redundant array of independent disks is removable from said enclosure, said TPM further being capable of encrypting at least a portion of information stored in said at least one disk.

10. The apparatus of claim 9, wherein said portion of said information stored in said at least one disk comprises parity data.

11. The apparatus of claim 7, wherein a host processor accesses said TPM via another link, said TPM further capable of mediating access to said TPM between said storage controller and said host processor.

12. The apparatus of claim 11, wherein if said host processor is accessing said TPM, said mediating access operation comprises waiting until said host processor is no longer accessing said TPM before allowing said storage controller to access said TPM.

13. An article comprising
a machine readable medium having stored thereon instructions that when executed by a machine results in the following:
accessing via a private link at least one security function provided by a trusted platform module (TPM); and
controlling storage of data in mass storage utilizing said at least one security function.

14. The article of claim 13, wherein said at least one security function comprises data encryption.

15. The article of claim 14, wherein said mass storage comprises a redundant array of independent disks in an associated enclosure, and wherein at least one disk of said redundant array of independent disks is removable from said enclosure, and wherein at least a portion of information stored in said at least one disk is encrypted.

16. The article of claim 13, wherein a storage controller accesses said TPM via said private link and wherein a host processor also accesses said TPM via another link, and wherein said instructions that when executed by said machine also results in mediating access to said TPM between said storage controller and said host processor.

17. A system comprising:
a circuit card comprising an integrated circuit, said circuit card capable of being coupled to a bus, said integrated circuit comprising a storage controller and a trusted platform module (TPM), said storage controller capable of accessing via a private link at least one security function provided by said TPM, said storage controller further being capable of controlling storage of data in mass storage utilizing said at least one security function.

18. The system of claim 17, wherein said at least one security function comprises data encryption.

19. The system of claim 18, wherein said mass storage comprises a redundant array of independent disks in an associated enclosure, and wherein at least one disk of said redundant array of independent disks is removable from said enclosure, said TPM further being capable of encrypting at least a portion of information stored in said at least one disk.

20. The system of claim 19, wherein said portion of said information stored in said at least one disk comprises parity data.

21. The system of claim 17, wherein a host processor also accesses said TPM via another link, said TPM further capable of mediating access to said TPM between said storage controller and said host processor.

22. The system of claim 21, wherein if said host processor is accessing said TPM, said mediating access operation comprises waiting until said host processor is no longer accessing said TPM before allowing said storage controller to access said TPM.

23. The system of claim 17, wherein said storage controller reserves a portion of said mass storage for internal storage needs of said TPM.
